(19) United States
(12) Patent Application Publication
(10) Pub. No.: US 2013/0346197 A1
(43) Pub. Date: Dec. 26, 2013

(54) CONTENT CATEGORY MANAGEMENT SYSTEMS AND METHODS

(71) Applicants: Qiang Zhou, San Bruno, CA (US); Ting Liu, Sunnyvale, CA (US); Xiaodan Song, San Jose, CA (US)

(72) Inventors: Qiang Zhou, San Bruno, CA (US); Ting Liu, Sunnyvale, CA (US); Xiaodan Song, San Jose, CA (US)

(73) Assignee: Google Inc.

(21) Appl. No.: 13/528,585

(22) Filed: Jun. 20, 2012

(51) Int. Cl. G06Q 30/02

(52) U.S. Cl. 705/14.53

(57) ABSTRACT

A method of managing content includes identifying a first web page presented during a user session associated with a first user identifier; identifying a first vertical category to which the first web page belongs; identifying an event occurring during the user session associated with the first user identifier; identifying a second vertical category to which the event belongs; generating association data representing an association between the first vertical category and the second vertical category; identifying a second web page, the second web page presented during a user session associated with a second user identifier; determining a vertical category to which the second web page belongs; and in response to determining the vertical category to which the second web page belongs is the first vertical category, selecting a content item for display during the user session associated with the second user identifier based on the association data.

### TECHNICAL FIELD

The disclosure relates generally to the field of content management, and, in particular, relates to systems and methods for matching content to user interests.

### BACKGROUND

The Internet provides access to a wide variety of content. The ability to search that content and provide intelligent search results to a user continues to be a challenge. Moreover, providing content related to services or items that the user would like to purchase can be beneficial to both the users and the content providers.

Content providers decide which content is displayed using various content management tools. These tools also allow a content provider to track the performance of various content items or content campaigns. The parameters used to determine when to display a particular content item can also be changed using content management tools.

### SUMMARY

A method of managing content includes (but is not limited to any one or combination of): (i) identifying a first web page presented during a user session associated with a first user identifier; (ii) identifying a first vertical category to which the first web page belongs; (iii) identifying an event occurring during the user session associated with the first user identifier; (iv) identifying a second vertical category to which the event belongs; (v) generating association data representing an association between the first vertical category and the second vertical category; (vi) identifying a second web page, the second web page presented during a user session associated with a second user identifier; (vii) determining a vertical category to which the second web page belongs; and (viii) in response to determining the vertical category to which the second web page belongs is the first vertical category, selecting a content item for display during the user session associated with the second user identifier based on the association data.

In various implementations, the selecting includes: selecting a content item belonging to the second vertical category; and providing the content item belonging to the second vertical category for display during the user session associated with the second user identifier.

In some implementations, the providing includes: providing the content item belonging to the second vertical category for display on the second web page during the user session associated with the second user identifier.

In further implementations, the method further includes: selecting a content item belonging to the first vertical category; and providing the content item belonging to the first vertical category along with the content item belonging to the second vertical category on the second web page.

In some implementations, the providing includes: providing the content item belonging to the second vertical category for display on a third web page during the user session associated with the second user identifier. The third web page may belong to a different vertical category than the first vertical category and the second vertical category.

In further implementations, the method further includes: selecting a content item belonging to a vertical category to which the third page belongs; and providing the content item belonging to the vertical category to which the third page belongs along with the content item belonging to the second vertical category on the third web page.

In some implementations, the providing includes: providing the content item belonging to the second vertical category for display with search results during the user session associated with the second user identifier.

In various implementations, the event comprises a page view of a web page belonging to the second vertical category.

In various implementations, the event comprises a selection of a content item belonging to the second vertical category.

In various implementations, the content item comprises an advertisement.

In some implementations, the event comprises a click through of the advertisement, the advertisement belonging to the second vertical category.

In some implementations, the event comprises conversion of the advertisement, the advertisement belonging to the second vertical category.

In various implementations, the user session associated with the first user identifier comprises one or more user sessions associated with the first user identifier in a particular time period.

In various implementations, the user session associated with the second user identifier comprises one or more user sessions associated with the second user identifier in a particular time period.

An apparatus for managing content includes a processor configured for: includes identifying a first web page presented during a user session associated with a first user identifier; identifying a first vertical category to which the first web page belongs; identifying an event occurring during the user session associated with the first user identifier; identifying a second vertical category to which the event belongs; generating association data representing an association between the first vertical category and the second vertical category; identifying a second web page, the second web page presented during a user session associated with a second user identifier; determining a vertical category to which the second web page belongs; and in response to determining the vertical category to which the second web page belongs is the first vertical category, selecting a content item for display during the user session associated with the second user identifier based on the association data.

A computer program product for managing content includes a computer-readable storage medium including code for: includes identifying a first web page presented during a user session associated with a first user identifier; identifying a first vertical category to which the first web page belongs; identifying an event occurring during the user session associated with the first user identifier; identifying a second vertical category to which the event belongs; generating association data representing an association between the first vertical category and the second vertical category; identifying a second web page, the second web page presented during a user session associated with a second user identifier; determining a vertical category to which the second web page belongs; and in response to determining the vertical category to which the second web page belongs is the first vertical category, selecting a content item for display during the user session associated with the second user identifier based on the association data.

### BRIEF DESCRIPTION OF THE DRAWINGS

FIG. 1 is a block diagram of an environment in which a content management system manages content according to various implementations of the disclosure.

FIG. 2 is flow chart of a method for managing content according to various implementations of the disclosure.

FIGS. 3A-3E are illustrative screenshots according to various implementations of the disclosure.

### DETAILED DESCRIPTION

Various implementations relate to content management systems that determine associations between vertical categories of events (e.g., web page views, click throughs, conversions, etc.) and select content items based on the associations.

A content management system may determine that an association exists between two vertical categories if users visiting pages of a first vertical category select content items or perform other events relating to a second vertical category within a predetermined period of visiting the pages of the first vertical category. Based on the association, the content management system may select content items belonging to the second vertical category to subsequent users who visit pages of the first vertical category. The content items belonging to the second vertical category may be provided on the pages of the first vertical category (in place or in addition to content items belonging to the first vertical category) or may be provided on other pages (e.g., a third vertical category) after such users visit the pages of the first vertical category. For instance, if the system determines that users who select content items of a second vertical category (e.g., hotel advertisements, which belong to a hotel vertical category) tend to have common interests relating to travel because many of the users had visited travel pages, which belong to a first vertical category (e.g., a travel vertical category) prior to selecting the hotel advertisements, the system may select hotel advertisements for providing on the travel pages or other pages visited by users who had visited travel pages.

As such, various implementations may predict user browsing behavior, and thus their interests, based on the browsing behavior of other users and then select a content item based on the predicted behavior. Such implementations are in contrast to selecting content items based on page's current content or the user's recent browsing history.

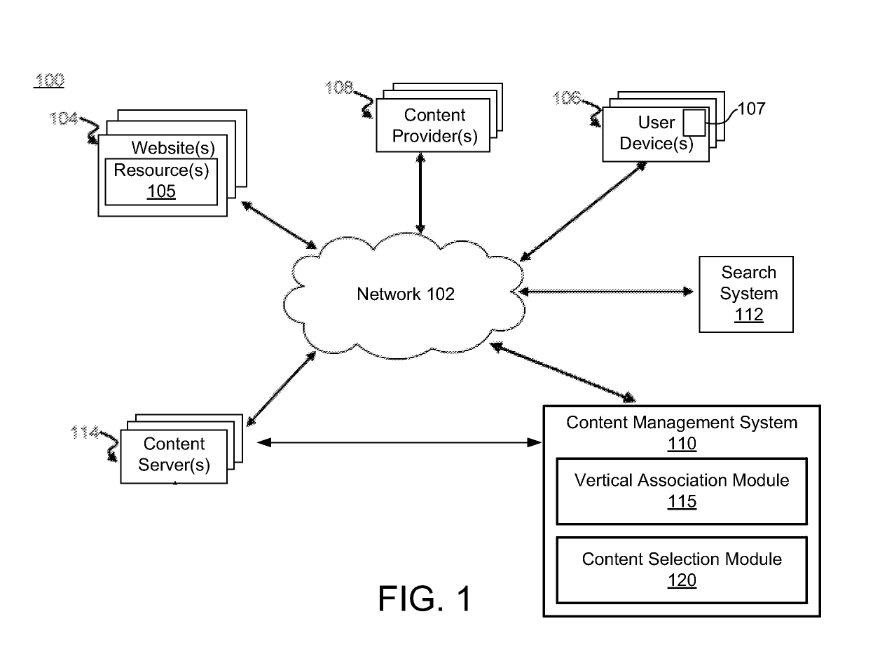

FIG. 1 is a block diagram of an environment in which a content management system manages content-providing services. The environment 100 includes a network 102, such as a local area network (LAN), a wide area network (WAN), the Internet, or a combination thereof. The network 102 connects websites 104, user devices 106, content providers 108, and a content management system 110. The environment 100 may include many thousands of websites 104, user devices 106, and content providers 108.

The website 104 is one or more resources 105 associated with a domain name and hosted by one or more servers. For instance, a website may be a collection of web pages formatted in hypertext markup language (HTML) that can contain text, images, multimedia content, and programming elements, such as scripts.

The resource 105 is any data that can be provided over the network 102. The resource 105 is identified by a resource address that is associated with the resource 105, such as a uniform resource locator (URL). The resource 105 may include web pages, word processing documents, portable document format (PDF) documents, images, video, programming elements, interactive content, feed sources, and/or any other type of content. The resource 105 can include content, such as words, phrases, images, and sounds, which may include embedded information (such as meta-information in hyperlinks) and/or embedded instructions (such as JavaScript™ scripts).

The user device 106 is an electronic device that is controllable by a user and is capable of requesting and receiving resources (e.g., 105) over the network 102. User devices 106 may include, but are not limited to, personal computers, mobile communication devices, and other devices that can send and receive data over the network 102. The user device 106 typically includes a user application, such as a web browser 107, to facilitate the sending and receiving of data over the network 102. The user device 106 may also be referred to as a computing device.

The user device 106 can request the resources 105 from the website 104 (or other resource server). In turn, data representing the resource 105 can be provided to the user device 106 for presentation by the user device 106. The data representing the resource 105 can include data specifying a portion of the resource 105 or a portion of a user display (e.g., a presentation location of a pop-up window or in a slot of a web page) in which a content item or other sponsored content item can be presented. These specified portions of the resource 105 or user display may be referred to as content slots. In some implementations, “content” or “content items” may refer to advertisements, and “content item” may refer to an advertisement. In such implementations, for instance, “content provider” may refer to advertisers or the like.

To facilitate searching of the vast number of resources 105 accessible over the network 102, the environment 100 can include a search system 112 that identifies the resources 105 by crawling and indexing the resources provided on the websites 104. Data about the resources can be indexed based on the resource with which the data is associated. The indexed and, optionally, cached copies of the resources are stored in a search index (not shown).

The user device 106 can submit search queries (e.g., via the browser 107) to the search system 112 over the network 102. In response, the search system 112 accesses the search index to identify resources that are relevant to the search query. In some implementations, a search query includes one or more keywords. The search system 112 identifies the relevant resources 105 in the form of search results and returns the search results to the user device 106 in search results pages. A search result is data generated by the search system 112 that identifies the resources 105 that are responsive to a particular search query, and includes a link to the resource 105. For instance, a search result can include a web page title, a snippet of text or a portion of an image extracted from the web page, a rendering of the resource, and the URL of the web page. Search results pages can also include one or more content slots in which one or more content items can be presented.

A search result page can be sent with a request from the search system 112 for the web browser 107 of the user device 106 to set an HTTP (HyperText Transfer Protocol) cookie. A cookie can represent, for example, a particular user device 106 and a particular web browser 107. For example, the search system 112 includes a server that replies to the query by sending the search results page in an HTTP response. This HTTP response includes instructions (e.g., a set cookie instruction) that cause the browser 107 to store a cookie for the site hosted by the server or for the domain of the server. If the browser 107 supports cookies and cookies are enabled, every subsequent page request to the same server or a server within the domain of the server will include the cookie. The cookie can store a variety of data, including a unique or semi-unique identifier. The unique or semi-unique identifiers are anonymized and are not connected with user names. Because HTTP is a stateless protocol, the use of cookies allows an external service, such as the search system 112 or other system, to follow particular actions and status of a user over multiple sessions. A user may, at any time, opt out of allowing user actions to be followed, for example, by disabling cookies in the browser 107 settings. According to various implementations, the search system 112 does not follow user identifying information. In some implementations, a user may be required to opt in to enable user actions to be followed.

When a resource 105 is requested by the user device 106, the content management system 110 receives a request for a content (one or more content items) to be provided with the resource 105. The request for content can include characteristics of the content slots that are defined for the requested resource 105 or search results page and can be provided to the content management system 110. For example, a reference (e.g., URL) to the resource 105 for which the content slot is defined, a size of the content slot, a position of the content slot within the resources, and/or media types that are available for presentation in the content slot can be provided to the content management system 110. Similarly, keywords associated with a requested resource (“resource keywords”) or a search query for which search results are requested can also be provided to the content management system 110 to facilitate identification of content items that are relevant to the resource 105 or search query.

Using data included in the request for content, the content management system 110 can select one or more content items that are eligible to be provided in response to the request (“eligible content item(s)” or “candidate content item(s)”). For example, the eligible content items may include content items having characteristics matching the characteristics of content slots and that are identified as relevant to specified resource keywords or search queries. In some implementations, content items having one or more keywords that match the resource keywords or the search query are selected as the eligible content items by the content management system 110.

The content management system 110 may select an eligible content item for each content slot of the resource 105. The resource 105 or search results page may be received by the user device 106 for presentation to the user, for instance on the browser 107. In some implementations, the selected content item may be delivered to the user device 106 via one or more content servers 114.

The content providers 108 can submit, to the content management system 110, campaign parameters (e.g., matching keywords and corresponding bids) that are used to control distribution of content items. The content providers 108 can access the content management system 110 to monitor performance of the content items that are distributed using the campaign parameters. For example, a content provider 108 can access a campaign performance report that provides a number of impressions (e.g., presentations), selections (e.g., clicks), and conversions (e.g., converting impressions into desired actions) that have been identified for the content items.

The campaign performance report can also provide a total cost, a cost-per-click, and other cost measures for the content items over a specified period. For example, a content provider 108 may access a performance report that specifies that content items distributed using the phrase match keyword “hockey” have received 1,000 impressions (e.g., have been presented 1,000 times), have been selected (e.g., clicked) 20 times, and have been credited with 5 conversions. Thus, the phrase match keyword “hockey” can be attributed with 1,000 impressions, 20 clicks, and 5 conversions.

One example of online content providing offers pay-per-click (PPC) content providing, cost-per-thousand (CPM) content providing, and site-specific content providing for text, banner, rich-media content, and/or the like. The program may include local, national, and international distribution. The text content can be short, for example comprising one headline of 25 characters and two additional text lines of 35 characters each. Image content can be one of several different Interactive Advertising Bureau (IAB) standard sizes.

In some implementations in which the content-providing campaign implements PPC content providing, content providers 108 may select words that should trigger their content items and the maximum amount they will pay per click. When a user searches on a search engine, content items for relevant words may appear as “sponsored links” on the (right or left) side of the page, and sometimes above or below the main search results. In some implementations, content items can appear on any portion of a page. The ordering of the paid-for listings may depend on other content providers' bids (PPC) and factors such as the “quality score” of all content items shown for a given search. In some implementations, the content management system 110 may determine the factors based on historical click-through rates (CTR), predicted click-through rates (pCTR), relevance of a content provider's content item text and keywords, a content provider's account history, and other relevance factors. The quality score may also be used to set the minimum bids for a content provider's keywords. The minimum bid may take into consideration the quality of the landing page as well, which may include the relevancy and originality of content, navigability, transparency into the nature of the business, and/or the like.

In some implementations, a “user” may refer to any company, organization, partnership, individual, agent, or entity that is involved in online content providing. Thus, in some implementations “user” and “content provider” can be used interchangeably. Keyword coverage refers to the number of searches done by “search engine users” that result in a paid result—a content item—being displayed. For example, 50% of searches conducted on a search engine may result in a paid content item being displayed. Out of that, 1% of the searches may result in a specific content provider's URL being provided. In general, the online content provider's goal is to have its content item(s) appear on a display page after as many relevant searches as possible. One way a content provider 108 can extend their keyword coverage is by purchasing additional keywords, thus increasing the likelihood that their content item(s) will appear on displays of search results. The number of paid results per keyword can vary, and where a URL ranks among the paid results may depend on several factors, including relevancy and the keyword purchase price.

There are several ways a content provider 108 may select keywords to purchase. For example, a content provider 108 may select a group of keywords that define the products, services, or content the content provider 108 offers on its web page. The content provider 108 may try to expand its keyword selection by selecting all synonyms, or by selecting keywords that are related, in some manner, to the products, services, or content the content provider 108 offers on its web page. The content provider 108 may try to optimize its selection of keywords by monitoring how effective each keyword is. For example, the content provider 108 may use a tool that records the number of times a purchased keyword is entered into a search engine and the number of times that results in the content provider's web page being viewed.

The content management system 110 includes or associates with a vertical association module 115. The vertical association module 115 generates association data representing associations between vertical categories. The associations between vertical categories are based on users' interests in the vertical categories, which are inferred from events that occurred during past user sessions of the users. In other implementations, the association between vertical categories can also be based on, for example, users' social networking profiles, users' browser data, users' activity patterns, users' friends, geographic data, and/or the like.

A past user session for a user can be identified in various ways. For example, a user account for the user (e.g., a user account for a search engine or other network system) can be used to identify a past user session for the first user. Each user account can be keyed to a user identifier that is uniquely associated with a user. The user identifier may be also associated with past user sessions for its account. Such an account-based user session may begin with the user logging into the user account and may be maintained until the user logs out of the account. Upon granting permission to follow the user's history (e.g., the user opts-in to allow the user's online activities to be followed), historical data for the user's sessions and other user data may be followed and associated with the user identifier. At the user's option, only data approved by the user may be followed (e.g., if the account is for a search engine, the user may specify that only search queries and search result selections be followed). The user can clear all historical data associated with the user account at any time, and can opt-out of such following at any time. Further, to protect the privacy of the user, the historical data can be anonymized so that the data cannot be associated with the user.

In some implementations, past user sessions for a particular user can also be identified based on an identifier associated with the client device 106 used by the user. For example, the IP address of the client device 106 can be used to infer a past user session for the user (e.g., the IP address of the client device 106 can be included in a request for information from a publisher).

In some implementations, upon the user granting permission, past user sessions can further be identified by access to and use of a data file stored on the client device 106. For example, a cookie stored on the client device 106 can be used to identify the client device 106 and access information about past online activities facilitated by the client device 106.

The events and associated information occurring during a user session of one or more users (e.g., a first user) can be stored in an event data store. The event data store can store data about events, such as advertisement click-throughs, web page views, conversions, user searches, video views, and/or the like. The data in the event data store can be partitioned, for example, according to users or user identifiers. A user profile data store can be used to store other information associated with the user such as declared profiles (e.g., social networking profiles), browser data (e.g., user agent), user activity patterns (e.g., time of day), users' friends, geographic data, and/or the like.

The vertical association module 115 may be configured to determine (e.g., predict) user interests for users (e.g., a second user) based on interests of other similar users (e.g., a first user) in particular vertical categories. The interests of the other similar users in the particular vertical categories can be determined based on events that occurred during the user sessions of the other similar users. The vertical association module 115 can categorize each of the events as belonging to one or more vertical categories based on the subject matter associated with the event and subject matter associated with the vertical categories. For example, a web page view event for a web page categorized in a sports vertical category can be categorized as belonging to the sports vertical category.

To facilitate the categorization process the vertical association module 115 can access vertical category data from a vertical category data store. The vertical category data may store data that categorizes web content according to the subject matter of the web content. For example, web pages that provide movie related information can be categorized in the entertainment/movies vertical category.

Web content can also be categorized by more than one vertical category. For example, a sports news web page may have a majority of its content directed to current events of different sports. However, the sports news web page may also include an abbreviated listing of a few sports-related programs. As such, the sports news web page may be categorized in both a sports vertical category and an entertainment/TV/TV programs vertical category.

Likewise, content (e.g., advertisements) and their associated landing pages can also be categorized in respective vertical categories, and the categorization can be stored in the vertical category data store.

The vertical association module 115 may generate association data that is representative of an association of a vertical category of a first event during the user session of the other similar users with a vertical category of a second event during the user session of the other similar users.

In some implementations, the association data is generated only if a predetermined threshold is met. For instance, an association between a first vertical category and a second vertical category is determined only if a predetermined amount or percentage of users visiting a page of the first vertical category perform an event relating to the second vertical category (e.g., visit a page belonging to the second vertical category).

The content management system 110 can include a content selection module 120. The content selection module 120 can select content items for user sessions associated with a user based on the association data representing associations between vertical categories. In some implementations, the content selection module 120, or the content management system 110, can identify or access information identifying a web page that is being presented on a user device (e.g., client device 106) during a user session for a user (e.g., a second user). For example, publishers may provide information identifying the web page being presented to the content selection module 120. The content selection module 120 can determine a vertical category to which the web page belongs, for example, from data stored in the vertical category data store.

The content selection module 120 can determine or identify a vertical category associated to the vertical category to which the web page belongs based on the association data. For example, if the web page belongs to an entertainment/music vertical category, the content selection module 120 can determine from the association data which vertical category or categories is (are) associated with the entertainment/music vertical category (e.g., has pages that are viewed by other user(s) following a visit to the web page belonging to the entertainment/music vertical category).

Once an associated vertical category has been determined, the content selection module 120 can select a content item that belongs to the vertical category determined to be associated with the vertical category to which the web page belongs (e.g., entertainment/music vertical category). The content selection module 120 can also select a content item belonging to the vertical category to which the web page belongs.

The content selection module 120 or the content management system 110 can then provide the content item selected from the associated vertical category and/or the content item from the vertical category to which the web page belongs for display on the user device 106.

Although the association data has been described in the context of selecting content items, the association data can also be used for other purposes. For example, the association data can be used to define clusters of users and permit content providers to provide content items to the clusters, to enhance content item click/conversion prediction models, to find user friends (e.g., like minded users), to create content survey panels to define a customer base, and/or the like.

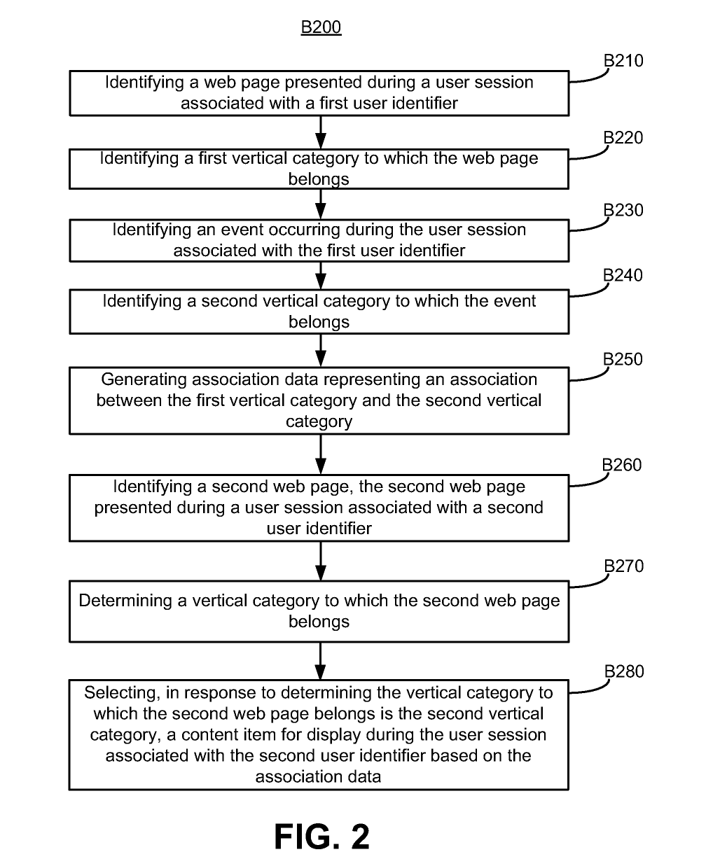

Various methods may be implemented using the content management system 100 from FIG. 1. For example, FIG. 2 is a method B200 that may be used to manage content based on vertical category association data in the content management system 110.

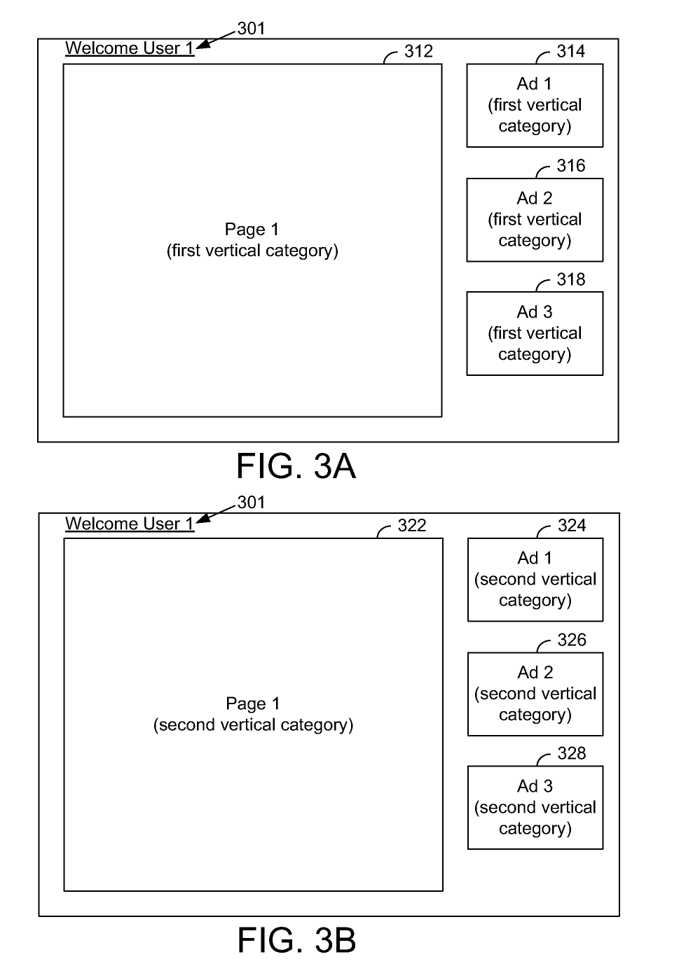

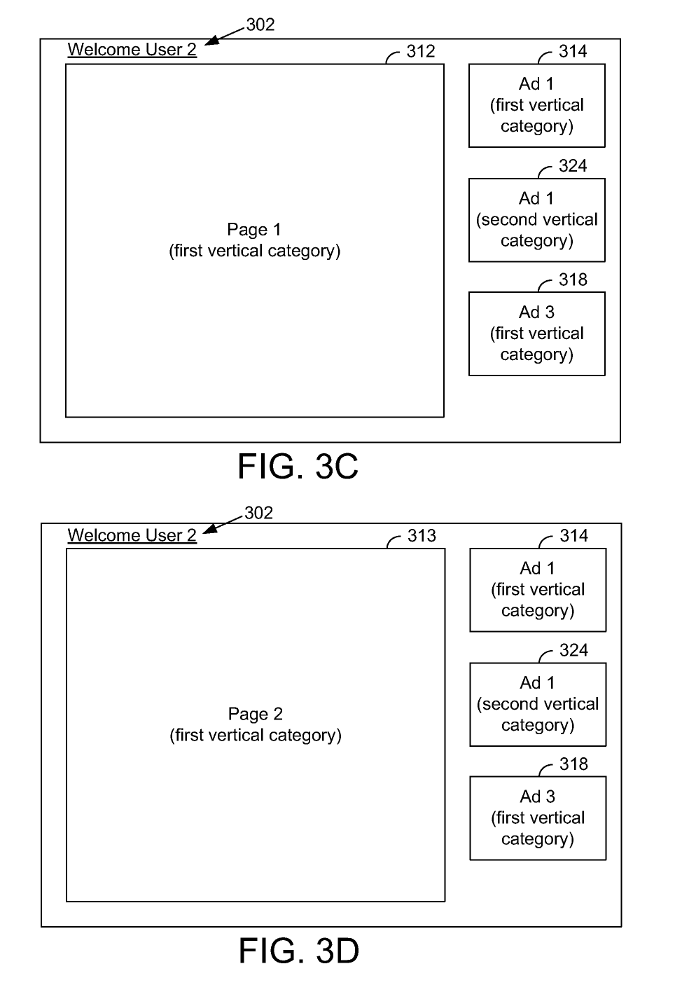

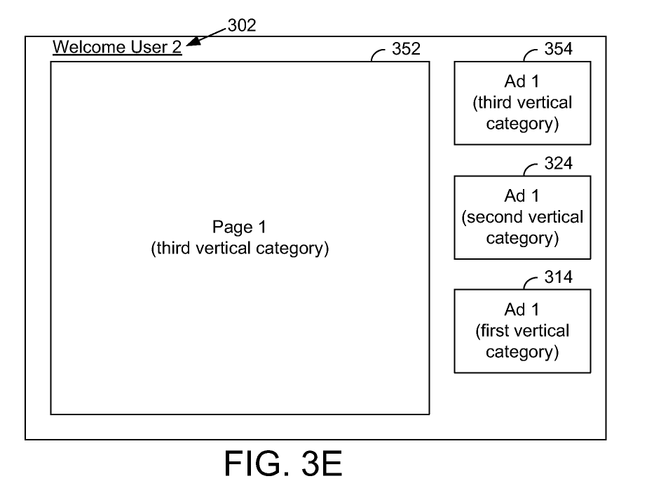

With reference to FIGS. 1 and 3E, at block B210, a (first) web page 312 presented during a user session associated with a first user identifier 301 (e.g., “User 1,” “John Doe,” etc.) may be identified. For instance, the management system 110 (e.g., the vertical association module 115) can identify or access information about the identity of the first web page 312 presented during the user session associated with the first user identifier 301. The first web page 312 may include or be associated with (e.g., presented with) one or more content items 314, 316, 316 (e.g., FIG. 3A).

At block B220, a (first) vertical category to which the first web page 312 belongs may be identified. For instance, the content management system 110 (e.g., the vertical association module 115) may identify the first vertical category to which the first web page 312 belongs. One or more of the content items 314, 316, 316 may also belong to the first vertical category.

At block B230, an event occurring during the user session associated with the first user identifier 301 may be identified (e.g., FIG. 3B). The event may include a view of a web page 322, a selection of one or more content items 324, 326, 328 (e.g., a click through of an advertisement), a conversion of the one or more content items 324, 326, 328, and/or the like. For instance, the content management system 110 (e.g., the vertical association module 115) may identify the event occurring during the user session associated with the first user identifier 301.

At block B240, a (second) vertical category to which the event belongs may be identified. For instance, the content management system 110 (e.g., the vertical association module 115) may identify the second vertical category to which the event belongs. One or more of the content items 324, 326, 328 may also belong to the second vertical category.

At block B250, association data representing an association between the first vertical category and the second vertical category is generated. For instance, the content management system 110 (e.g., the vertical association module 115) may generate the association data representing an association between the first vertical category and the second vertical category. Thus in particular implementations, in blocks B210-B240, a user session of one or more first users (or user identifier(s)) may be used to generate association data (training data) for selecting content items for display or presentation during a user session of one or more second users (or user identifier(s)).

At block B260, a (second) web page 313 may be identified. The second web page 313 may be presented during a user session associated with a second user identifier 302 (e.g., “User 2,” “Jane Doe,” etc.). For instance, the management system 110 (e.g., the content selection module 120) may identify or access information about the identity of the second web page 313 presented during the user session associated with the second user identifier 302. The second web page 313 may be different from the first web page 312 (e.g., FIG. 3D). In other implementations, the second webpage may be the same as the first web page 312 (e.g., FIG. 3C).

At block B270, a vertical category to which the second web page 313 belongs may be determined. For instance, the management system 110 (e.g., the content selection module 120) may determine the vertical category to which the second web page belongs.

At block B280, in response to the second web page 313 being determined as belonging to the first vertical category, a content item (e.g., 324) may be selected for display during the user session associated with the second user identifier 302 based on the association data. For instance, the management system 110 (e.g., the content selection module 120), in response to the second web page being determined as belong to the first vertical category, may select the content item for display during the user session associated with the second user identifier based on the association data.

In some implementations, the selected content item for display during the user session associated with the second user identifier 302 may be a content item 324 belonging to the first vertical category. Other content items (e.g., 314, 318), such as content items belong to the second vertical category may also be provided.

In some implementations, the selected content item (e.g., 324) is for display with the web page (e.g., 312, 313) of the first vertical category (e.g., FIGS. 3C, 3D). In other implements, the selected content item (e.g., 354) is for display with a web page 352 that belongs to a different vertical category (e.g., a third category) than the first vertical category and the second vertical category (e.g., FIG. 3E). For instance, the page 352 may be one visited by the second user identifier 302 subsequent the second user identifier 302 visiting a page belonging to the first vertical category.

In some implementations, the content management system 110 may select a content item from the first vertical category for providing on pages belonging to the second vertical category (in addition or in place of content items from the second vertical category).

It is understood that the specific order or hierarchy of steps in the processes disclosed is an example of illustrative approaches. Based upon design preferences, it is understood that the specific order or hierarchy of steps in the processes may be rearranged while remaining within the scope of the present disclosure. The accompanying method claims present elements of the various steps in a sample order, and are not meant to be limited to the specific order or hierarchy presented.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, circuits, and algorithm steps described in connection with the implementations disclosed herein may be implemented as electronic hardware, computer software embodied on a tangible medium, or combinations of both. To clearly illustrate this interchangeability of hardware and software, various illustrative components, blocks, modules, circuits, and steps have been described above generally in terms of their functionality. Whether such functionality is implemented as hardware or software embodied on a tangible medium depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the implementations disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the implementations disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An illustrative storage medium is coupled to the processor such the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

In one or more illustrative implementations, the functions described may be implemented in hardware, software or firmware embodied on a tangible medium, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. In addition, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk, and Blu-Ray disc where disks usually reproduce data magnetically, while discs reproduce data optically with lasers. Combinations of the above should also be included within the scope of computer-readable media.

The previous description of the disclosed implementations is provided to enable any person skilled in the art to make or use the present disclosure. Various modifications to these implementations will be readily apparent to those skilled in the art, and the generic principles defined herein may be applied to other implementations without departing from the spirit or scope of the disclosure. Thus, the present disclosure is not intended to be limited to the implementations shown herein but is to be accorded the widest scope consistent with the principles and novel features disclosed herein.

What is claimed is:

1. A method of managing content, the method comprising:
identifying a first web page presented during a user session associated with a first user identifier;
identifying a first vertical category to which the first web page belongs;
identifying an event occurring during the user session associated with the first user identifier;
identifying a second vertical category to which the event belongs;
generating association data representing an association between the first vertical category and the second vertical category;
identifying a second web page, the second web page presented during a user session associated with a second user identifier;
determining a vertical category to which the second web page belongs; and
in response to determining the vertical category to which the second web page belongs is the first vertical category, selecting a content item for display during the user session associated with the second user identifier based on the association data.

2. The method of claim 1, wherein the selecting comprises:
selecting a content item belonging to the second vertical category; and
providing the content item belonging to the second vertical category for display during the user session associated with the second user identifier.

3. The method of claim 2, wherein the providing comprises:
providing the content item belonging to the second vertical category for display on the second web page during the user session associated with the second user identifier.

4. The method of claim 3, the method further comprising:
selecting a content item belonging to the first vertical category; and
providing the content item belonging to the first vertical category along with the content item belonging to the second vertical category on the second web page.

5. The method of claim 2, wherein the providing comprises:
providing the content item belonging to the second vertical category for display on a third web page during the user session associated with the second user identifier;
wherein the third web page belongs to a different vertical category than the first vertical category and the second vertical category.

6. The method of claim 5, the method further comprising:
selecting a content item belonging to a vertical category to which the third page belongs; and
providing the content item belonging to the vertical category to which the third page belongs along with the content item belonging to the second vertical category on the third web page.

7. The method of claim 2, wherein the providing comprises:
providing the content item belonging to the second vertical category for display with search results during the user session associated with the second user identifier.

8. The method of claim 1, wherein the event comprises a page view of a web page belonging to the second vertical category.

9. The method of claim 1, wherein the event comprises a selection of a content item belonging to the second vertical category.

10. The method of claim 1, wherein the content item comprises an advertisement.

11. The method of claim 10, wherein the event comprises a click through of the advertisement, the advertisement belonging to the second vertical category.

12. The method of claim 10, wherein the event comprises conversion of the advertisement, the advertisement belonging to the second vertical category.

13. The method of claim 1, wherein the user session associated with the first user identifier comprises one or more user sessions associated with the first user identifier in a particular time period.

14. The method of claim 1, wherein the user session associated with the second user identifier comprises one or more user sessions associated with the second user identifier in a particular time period.

15. An apparatus for managing content, the apparatus comprising:
a processor configured for:
identifying a first web page presented during a user session associated with a first user identifier;
identifying a first vertical category to which the first web page belongs;
identifying an event occurring during the user session associated with the first user identifier;
identifying a second vertical category to which the event belongs;
generating association data representing an association between the first vertical category and the second vertical category;
identifying a second web page, the second web page presented during a user session associated with a second user identifier;
determining a vertical category to which the second web page belongs; and
in response to determining the vertical category to which the second web page belongs is the first vertical category, selecting a content item for display during the user session associated with the second user identifier based on the association data.

16. The apparatus of claim 15, wherein the selecting comprises:
selecting a content item belonging to the second vertical category; and
providing the content item belonging to the second vertical category for display during the user session associated with the second user identifier.

17. The apparatus of claim 15, wherein the content item comprises an advertisement.

18. A computer program product for managing content, the computer program product comprising:
a computer-readable storage medium comprising code for:
identifying a first web page presented during a user session associated with a first user identifier;
identifying a first vertical category to which the first web page belongs;
identifying an event occurring during the user session associated with the first user identifier;
identifying a second vertical category to which the event belongs;
generating association data representing an association between the first vertical category and the second vertical category;
identifying a second web page, the second web page presented during a user session associated with a second user identifier;
determining a vertical category to which the second web page belongs; and
in response to determining the vertical category to which the second web page belongs is the first vertical category, selecting a content item for display during the user session associated with the second user identifier based on the association data.

19. The computer program product of claim 18, wherein the selecting comprises:
selecting a content item belonging to the second vertical category; and
providing the content item belonging to the second vertical category for display during the user session associated with the second user identifier.

20. The computer program product of claim 18, wherein the content item comprises an advertisement.
